(19) United States
(12) Patent Application Publication
(10) Pub. No.: US 2009/0122880 A1
(43) Pub. Date: May 14, 2009

(54) FILTER FOR BPL SIGNAL

(76) Inventor: Michael Keselman, San Ramon, CA (US)

Correspondence Address: DICKSTEIN SHAPIRO LLP, 1825 EYE STREET NW, Washington, DC, 20006-5403, US

(21) Appl. No.: 12/268,191

(22) Filed: Nov. 10, 2008

Related U.S. Application Data
(60) Provisional application No. 60/996,269, filed on Nov. 8, 2007.

(51) Int. Cl. H04B 3/00

(52) U.S. Cl. 375/257

(57) ABSTRACT

A filter system for a broadband over power line system comprises a power line and a first line node and second line node of the broadband over power line system using the power line. The filter system also comprises a filter on the power line placed between the first and second line node, to attenuate a range of frequencies. Wherein the range of frequencies can be the entire range of mode frequencies used in the broadband over power lines system.

### CROSS-REFERENCE TO RELATED APPLICATIONS

This application claims the benefit of U.S. Provisional Appl. No. 60/996,269 filed Nov. 8, 2007, the entire disclosure of which is incorporated herein by reference.

### FIELD OF THE INVENTION

Embodiments of the invention relate generally to the field of broadband communication signals transmitted over power lines, and more particularly, to the isolation of carrier modes.

### BACKGROUND OF THE INVENTION

High-speed Internet access, commonly known as “broadband,” is defined by the FCC as Internet access providing download speeds of at least 200 kbit/s. While the demand for communications systems capable of carrying broadband Internet access continues to grow, the technology requires a transmission infrastructure. Broadband providers currently use the existing cable infrastructure, or, alternatively, the existing telephone infrastructures to provide service into homes. As an alternative transmission medium, the existing infrastructure for power lines would provide access to many areas not covered by cable or telephone lines. The prior art discloses the technology to carry a broadband Internet signal over power lines. See Communication System for Providing Broadband Data Services Using a High-Voltage Cable of a Power System, U.S. Pat. No. 6,040,759 (filed Feb. 17, 1998) ('759 patent).

Broadband Over Power Line (“BPL”) technology uses the existing power line infrastructure to carry a broadband Internet signal, potentially providing access to any location connected to the power grid. A radio-frequency signal at a first location (or node) is modulated with a data signal and coupled to a high-voltage cable serving as a transmission channel. The modulated RF signal's frequency is typically much higher than the AC power current. At a second node, the radio-frequency signal is decoupled from the high-voltage cable to a demodulator for converting the modulated signal back to a data signal. One of the options is to use Frequency Division Multiplexing when the data is sent from the second node to the first node in a similar manner typically using a different band of frequencies. Attenuation of the broadband signal along the line is remedied with repeaters or regenerators, which reestablish the signal's strength. This full-duplex broadband service between the locations may simultaneously supply a variety of communication needs, such as telephone service, video service, internet service, and other services requiring high-speed data transfers.

According to the Frequency Division schema, the RF carrier signal is transmitted in multiple frequency bands, or “modes.” In order to reduce interference between nodes using the same frequencies, the modes alternate between consecutive nodes along the power line. If identical or similar modes (i.e. carrier signals of the same frequency) overlap, interference of the data transmission can result. There is a fair amount of RF signal reach from one node to the next. Therefore, the modes are alternated between each node resulting in different carrier frequencies for adjacent nodes. This reduces, yet does not eliminate, the potential for overlap of the same or similar carrier frequencies.

As currently understood in the industry, a broader frequency band permits a greater transmission speed. For example, while with current technology 30 MHz-wide frequency spectrum might allow a transmission of 200 Mbps, a 10 MHz-wide frequency spectrum might allow a transmission of only 85 Mbps. However, there is a finite amount of spectrum allotted to the transmission of BPL signals, currently approximately 30 MHz wide. Therefore, the ideal configuration for a BPL system includes the minimal number of modes (allowing for the maximum bandwidth allotment for each mode), while maintaining separation between identical modes. This balance between bandwidth and interference limits the number of nodes which can be placed within a certain distance.

### BRIEF SUMMARY OF THE INVENTION

A filter system for a broadband over power line system comprises a power line and a first line node and second line node of the broadband over power line system using the power line. The filter system also comprises a filter on the power line placed between the first and second line node, to attenuate a range of frequencies used in the broadband over power lines system to allow for the use of a broader frequency band on the power line. Wherein the range of frequencies can be the entire range of mode frequencies used in the broadband over power lines system.

### BRIEF DESCRIPTION OF THE DRAWINGS

FIG. 1 is a diagram of a BPL system with filters, in accordance with embodiments described herein;

FIG. 2 is an approximated spectral diagram of an embodiment described herein using a low pass filter configuration; and

FIG. 3 is an approximated spectral diagram of an embodiment described herein using a band pass filter configuration.

### DETAILED DESCRIPTION OF THE INVENTION

The present invention discloses a network filter which will strengthen the robustness of the separation between similar modes on broadband over power lines (“BPL”). An embodiment of the present invention attenuates the entire frequency range of all carrier modes on the particular BPL system for which it is employed. The filter is placed in an “in-line” location, meaning on the power line itself, rather than on the adjoining coupler.

The filter will allow reuse of the same modes within shorter distances than the prior art, with reduced risk of interference. An embodiment described herein will allow the placement of regenerators at closer distances, allowing more flexibility when multiple nodes must be placed near each other. The present invention also enables the use of broader frequency bands, because overlap of modes is no longer as problematic.

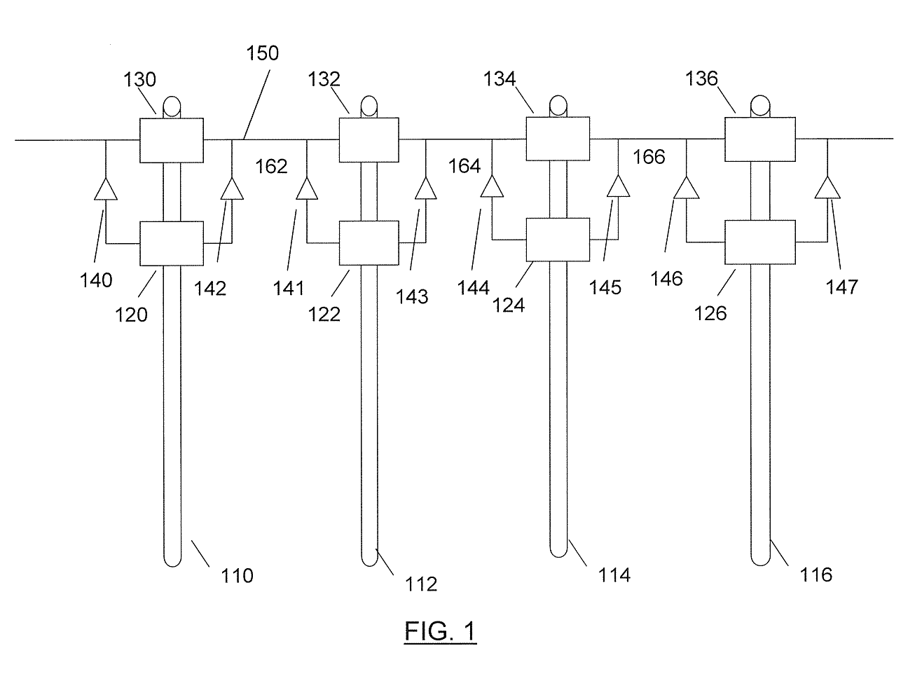

FIG. 1 shows an embodiment of the invention comprising: first, second, third, and fourth utility poles poles, 110, 112, 114 and 116; first, second, third and fourth BPL regenerators, 120, 122, 124, and 126; first, second, third and fourth filters 130, 132, 134, and 136; first through eighth BPL couplers 140-147; medium voltage power line 150 and first, second, and third line nodes 162, 164, and 166.

First through eighth BPL couplers 140-147 are connected between the BPL regenerators 130, 132, 134, 136 and the medium voltage line 150. Each utility pole 110, 112, 114, 116 is coupled to a respective regenerator 120, 122, 124, 126. Each filter 130, 132, 134, 136 is coupled to the medium voltage line 150. The first filter 130 is coupled to the medium voltage line 150 between first and second couplers 140 and 141. The second filter 132 is coupled to the medium voltage line 150 between first and second couplers 142 and 143. The third filter 134 is coupled to the medium voltage line 150 between first and second couplers 144 and 145. The fourth filter 136 is coupled to the medium voltage line 150 between first and second couplers 146 and 147. First, second, and third line nodes 162, 164, and 166 are part of the medium power line 150. The first line node 162 is between first filter 130 and second filter 132. Where the first line node 162 couples the couplers 141 and 142. The second line node 164 is between second filter 132 and third filter 134. Where the second line node 164 couples the couplers 143 and 144. The third line node 166 is between third filter 134 and fourth filter 136. Where the third line node 166 couples the couplers 145 and 146.

A segment of a medium power line 150 in BPL carries a power current and a data signal modulated at a carrier frequency or “mode.” The present invention involves filters 130, 132, 134, 136 within the power line, also referred to as “in-line” filters. The in-line filter permits the power current, transmitting at a much lower frequency, to pass unaffected. The data signal, is coupled from the medium power line 150 by first coupler 140 and demodulated from the carrier signal by regenerator 120. The data signal is modulated at a different mode frequency by regenerator 120 and coupled to the medium power line 150 by the second coupler 141 allowing the data to be transmitted along the next segment of the power line. Thus, the same mode frequencies for the data signal can be reused in line nodes 162 and 166 without interference.

In an embodiment of the present invention, the entire carrier frequency range is attenuated by filters 130, 132, 134, 136 between each line node 162, 164, and 166. In current technology, the allotted frequency spectrum for BPL is approximately 2 MHz-30 MHz. While reference will be made herein to this particular frequency range in discussion of examples, the invention is not limited to implementation in this particular frequency range, and embodiments for other frequency ranges are within the scope of the invention.

The invention can be implemented through several alternative embodiments. Detailed below are embodiments using a low pass filter configuration and a band stop filter configuration. However, the described invention may be implemented through other configurations and combinations thereof which stop the entire mode range, and the invention is not limited to a particular filter configuration.

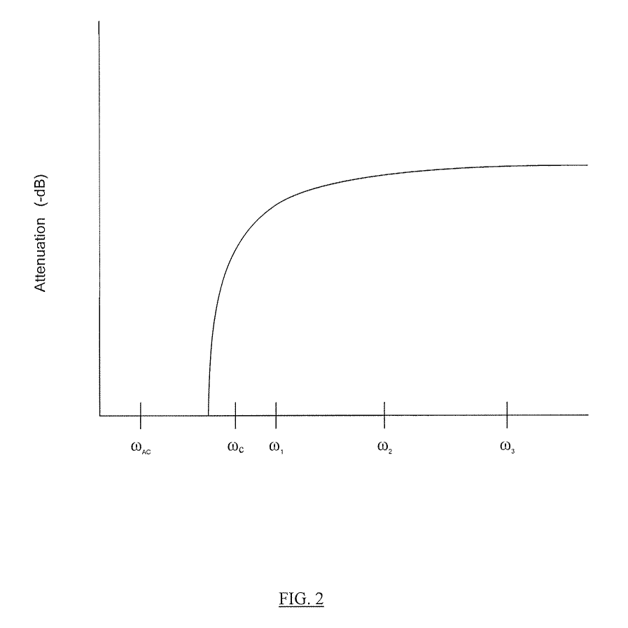

One embodiment is a low pass filter configuration, which attenuates all carrier frequencies above its cutoff frequency. The embodiment has no effect on frequencies in the range of the AC power current, allowing the AC power signal (ω_{AC}) to pass through unaffected. The embodiment blocks all frequencies equal to or greater than the minimum frequency used in any of the RF carrier modes, preventing overlap to other nodes, while leaving the power signal unaffected. FIG. 2 is an approximated spectral diagram of an embodiment described herein using a low pass filter configuration, with power current frequency of ω_{AC}, three modes at frequencies ω₁, ω₂, and ω₃, and the cutoff frequency of the filter at ω_{C}.

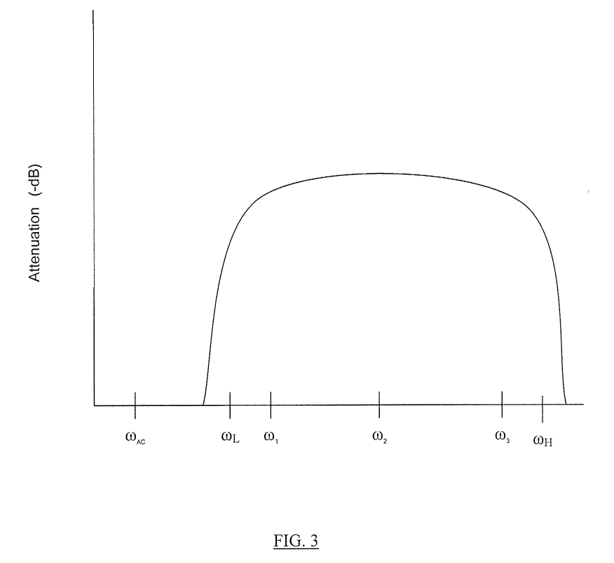

A embodiment using a band stop filter configuration accomplishes a similarly beneficial result. The resulting filter has a low-cutoff frequency (ω_{L}) below the minimum RF carrier frequency included in any of the broadband modes, yet above the frequency of the AC power signal. The high-cutoff frequency (ω_{H}) extends above the highest frequency of any of the RF carrier modes. FIG. 3 is an approximated spectral diagram of an embodiment described herein using a band stop filter configuration, with power current frequency of ω_{AC}, three carrier modes at frequencies ω₁, ω₂, and ω₃, the lower cutoff frequency of the filter at ω_{L}, and the high-cutoff frequency of the filter at ω_{H}.

Employing an embodiment of the present invention, the entire range of modes used to carry the broadband signal is thus filtered out of the power line between each node. This allows for regenerators and nodes to be placed at closer distances to one another with reduced risk of interference, providing both noise reduction and flexibility in design. The invention also enables the use of broader frequency bands for each node, as the need for numerous different modes is eliminated by the more efficient isolation.

### EXAMPLES

For example, with a BPL carrier frequency range of 2 MHz-30 MHz and an AC power frequency of 60 Hz, one embodiment would be a low pass filter configuration with a cutoff frequency (ω_{c}) above 60 Hz but below 2 MHz.

For another example, with a BPL carrier frequency range of 2 MHz-30 MHz, and an AC power frequency of 60 Hz, one embodiment would be a band stop filter with a low-cutoff frequency above 60 Hz but below 2 MHz, and a high-cutoff frequency above 30 MHz.

The devices and configurations in the above descriptions illustrate examples of devices that could be used and produced to achieve the objects, features, and advantages of embodiments described herein. For example, several other filter configurations could be employed to attenuate the entire frequency range of the carrier modes, such as a notch filter configuration or a band pass filter configuration with a pass band in the range of the AC power current. Thus, the embodiments of the invention are not to be seen as limited by the foregoing description of the embodiments, but only limited by the appended claims.

What is claimed as new and desired to be protected by Letters Patent of the United States is:

1. A filter system for a broadband over power line system comprising:
a power line;
a first line node of the broadband over power line system using the power line;
a second line node of the broadband over power line system using the power line; and
a filter on the power line placed between the first and second line nodes, to attenuate a range of frequencies used in the broadband over power lines system to allow for the use of a broader frequency band on the power line.

2. The filter system of claim 1, wherein the range of frequencies is greater than 20 KHz.

3. The filter system of claim 1, wherein the range of frequencies is an entire range of frequencies used in the broadband over power lines system.

4. The filter system of claim 1, wherein the range of frequencies is at least part of a range of mode frequencies used in the broadband over power lines system.

5. The filter system of claim 1, wherein the filter used is a low pass filter configuration.

6. The filter system of claim 1, wherein the filter used is a band stop filter configuration.

7. The filter system of claim 1, wherein the filter used is a band pass filter configuration.

8. The filter system of claim 1, wherein the filter used is a notch filter configuration.

9. The filter system of claim 1, wherein the filter used consists of a combination of filters.

10. A method of isolating carrier modes on multiple segments of a broadband over power lines system comprising attenuating a range of frequencies used for the broadband over power lines system on a power line between each line node of the broadband over power lines system.

11. The method of claim 10, wherein the range of frequencies is greater than 20 KHz.

12. The method of claim 10, where in the range of frequencies is an entire range of mode frequencies used in the broadband over power lines system.

13. The method of claim 10, where in the range of frequencies is at least part of a range of mode frequencies used in the broadband over power lines system.

14. The method of claim 10, wherein the attenuation is implemented using a low pass filter configuration.

15. The method of claim 10, wherein the attenuation is implemented using a band stop filter configuration.

16. The method of claim 10, wherein the attenuation is implemented using a band pass filter configuration.

17. The method of claim 10, wherein the attenuation is implemented using a notch filter configuration.

18. The method of claim 10, wherein the attenuation is implemented using a combination of filter configurations.
